(19) United States
(12) Patent Application Publication
(10) Pub. No.: US 2020/0256490 A1
(43) Pub. Date: Aug. 13, 2020

(54) ENHANCED HOSE FITTING AND METHOD OF ASSEMBLY

(71) Applicant: Parker-Hannifin Corporation, Cleveland, OH (US)

(72) Inventors: Derek M. Garceau, Cleveland Heights, OH (US); Andrew M. Morgan, Lakewood, OH (US); Don Groce, Mentor, OH (US); Merle S. Barber, Chardon, OH (US)

(21) Appl. No.: 16/641,921

(22) PCT Filed: Aug. 30, 2018
(86) PCT No.: PCT/US2018/048717

§ 371 Date: Feb. 25, 2020

Related U.S. Application Data
(60) Provisional application No. 62/568,849, filed on Oct. 6, 2017.

(51) Int. Cl. F16L 33/207; F16L 33/01

(52) U.S. Cl. CPC F16L 33/2076; F16L 33/223; F16L 33/01

(57) ABSTRACT

A hose fitting (10) includes a nipple (12) with a first end that is insertable into a hose and a second opposite end (22), nipple mating threads (38) located between the first (18) and second ends (22), and a shoulder (42) located between the mating threads and the second end (22) and that projects radially outward relative to the nipple (12) mating threads. A nut (16) is positioned over the second end (22) of the nipple (12). A shell (14) is positioned over the first end of the nipple (12) and includes shell mating threads (48), wherein the shell is threaded onto the nipple (12) by a threaded connection of the nipple mating threads (38) and the shell mating threads (48). The shoulder (42) operates to prevent further rotation of the shell (14), and the resulting torque locks the shell (14) in place and provides a seal against leakage from the fitting assembly. The nipple (12) includes a planar surface (40) that extends from the mating threads (38) to a second planar surface (26) that meet to form the shoulder (42).

### RELATED APPLICATIONS

This application claims the benefit of U.S. Provisional Application No. 62/568,849 filed Oct. 6, 2017, which is incorporated herein by reference.

### FIELD OF INVENTION

The present invention relates generally to hose couplings or hose fittings suitable for use in joining hose sections to system equipment in fluid flow systems, such as for example in hydraulic fluid systems

### BACKGROUND OF THE INVENTION

Hydraulic hose couplings and fittings may be subjected to substantial fluid pressures. Accordingly, hose fittings must be durable and provide a strong connection of hose sections to system equipment without fluid leakage.

In conventional configurations, a hose fitting may include a nipple that can be inserted into a hose at a first end. The first end of the nipple may include outer ribs or barbs that can provide a tight friction fit with a hose when the nipple is inserted into the hose. The hose fitting further may include a shell that extends around the first end of the nipple that is inserted into the hose. The hose fitting further may include a nut that extends around a second end of the nipple opposite from the first end that includes the shell, and the nut can provide a connection to fluid system equipment. During initial assembly, an inner surface of the shell and an outer surface of the nipple may be spaced apart. Accordingly, when the nipple is inserted into the hose, the hose end extends between the outer surface of the nipple and the inner surface of the shell. The shell may then be crimped onto the hose to secure the hose and the fitting together. The inner surface of the shell may include barbs or teeth that can dig or “bite” into the outer hose layer to provide a secure connection.

In many conventional configurations, the nut tends to be hex shaped, and tightening the nut to system equipment can be countered by an opposing hex surface to prevent the fitting from spinning so that the nut can be tightened. In conventional configurations, the opposing hex counter typically is provided on the nipple, which typically requires the nipple to be machined from a hex bar stock or machining the hex shape from round bar stock to achieve appropriately shaped surfaces. The nut also may be “pre-crimped” onto the shell, which in some circumstances provides for an insufficiently robust connection. The typical assembly method of these component parts further would be to swage or crimp one end of the shell onto a designated area on the nipple. The swaging process creates a metal-to-metal connection between the shell and nipple, which constitutes an additional step in the assembly.

For such assembly, as referenced above, it commonly is needed to machine the nipple from a hex-shaped bar stock comparable to the hex shape of a standard nut. The nut comparably would be machined from separate bar stock and then pre-crimped onto the fitting in a secondary operation as referenced above. In addition, machining of a conventional nipple component requires extra machining time and material removal to create specific shapes where the shell mates to the nipple. Many of these shapes require a large diameter to achieve, which means the nipple must be cut from bar stock that is larger than is necessary for many other features, which results in a high portion of wasted machined material. Based on such operations, conventional machining of the component parts of typical hose fittings, and their related assembly, constitute complex and costly processes.

### SUMMARY OF THE INVENTION

The present invention provides for an enhanced hose fitting configuration that is easier and less costly to manufacture and assemble as compared to conventional configurations. The invention provides for a unique application of a left-handed thread on the shell and nipple portions of a non-reusable hose fitting. As referenced above, the typical assembly method for conventional hose fitting component parts is to swage or pre-crimp one end of the shell onto a designated area on the nipple to create a metal-to-metal connection between the shell and nipple. In configurations of the present disclosure, both the nipple and shell are threaded together to create the connection. The shell is threaded onto the nipple until reaching a shoulder on the nipple that prevents further rotation of the shell. The resulting torque locks the shell in place and prevents leakage as well as further shell rotation. The use of certain thread types or a thread lock compound applied to the threads could also be used to create a more robust connection.

The invention offers significant cost reduction opportunities, both in the initial machining of the component parts of the hose fitting as well as during simplified assembly and secondary operations. The hose fitting components typically are made from steel, stainless steel, brass, or comparable suitable material. As referenced above, the hose fitting components may include a nipple with a first end formed with ribs or barbs on the external surface to receive the hose, and a second end on which there is provided a nut or comparable component for connection to system equipment. Machining of a conventional nipple component has required extra machining time and material removal to create specific shapes where the shell mates to the nipple and to counter the tightening of the nut. Many of these shapes require a large diameter to achieve, which means the nipple must be cut from bar stock, and usually a hex bar stock, that is larger than is necessary for machining other features to be formed in the nipple, which results in significant waste of machined material. Because the nipple of the present disclosure incorporates a simple small shoulder on the outside of the nipple at an end of the threaded area to prevent further shell rotation, such configuration permits a smaller and rounded bar stock to be used as the base material. The shell of the present disclosure also includes an integrated hex portion rather than providing the counter hex portion on the nipple, which also permits use of a smaller and rounded bar stock. A smaller and rounded bar stock is less expensive and more efficient to machine as compared to conventional configurations.

In fittings that employ a nut at the end for connection to system equipment, the configuration of the present disclosure permits a full back slip nut interaction with respect to the nipple rather than a pre-crimped connection. The full back slip nut, therefore, can be efficiently produced by cold forming the nut rather than being machined from bar stock and then crimped onto the nipple in a secondary operation as described above. This full back slip nut configuration provides a more robust connection with the nipple due to the geometric advantages of the interaction of the nut and the nipple. A stronger nut is therefore usable. There also is no need to fix the nut location with additional threading in the nipple, or to provide additional washers, o-rings, other seals, and like additional components that are employed in some variations of conventional configurations to locate the nipple and otherwise seal the fitting. Additionally, the configuration of the present invention allows the fitting components to be individually plated prior to assembly, increasing the plating coverage and thus anti-corrosion performance.

As aspect of the invention is a hose fitting that employs mating threads and a shoulder machined into the nipple to provide a better assembly of the nipple with the shell. In exemplary embodiments, a hose fitting assembly includes a nipple that includes a first end that is insertable into a hose and a second end opposite to the first end, nipple mating threads located between the first and second ends, and a shoulder that is located between the mating threads and the second end and that projects radially outward relative to the nipple mating threads. A nut is positioned over the second end of the nipple. A shell is positioned over the first end of the nipple and includes shell mating threads, wherein the shell is threaded onto the nipple by a threaded connection of the nipple mating threads and the shell mating threads until the shell meets the shoulder. When the shell is threaded onto the nipple, the shoulder operates to prevent further rotation of the shell, and the resulting torque of the interaction of the shell against the shoulder locks the shell in place and provides a seal against leakage from the fitting assembly. The nipple includes a shell locating planar surface that extends from the nipple mating threads towards the second end to a second planar surface, wherein the shell locating planar surface and the second planar surface have different diameters so as to meet to form the shoulder.

Another aspect of the invention is a simplified method of assembling a hose fitting assembly with features described herein. In exemplary embodiments, the assembly method may include the steps of sliding the nut onto the nipple from the first end toward the second end, wherein the nipple has a step and the nut has a lip, and the step acts as a stop against the lip of the nut to prevent movement of the nut off of the second end of the nipple. The method further includes threading the shell onto the nipple by the threaded connection of the nipple mating threads to the shell mating threads until the shell meets the shoulder. When the shell is threaded onto the nipple the shoulder operates to prevent further rotation of the shell, and the resulting torque of the interaction of the shell against the shoulder locks the shell in place and provides a seal against leakage from the fitting assembly. The nut, nipple, and shell may be assembled in the above manner, and after threading the shell onto the nipple, the first end of the nipple may be inserted into the hose, and a crimping end of the shell is crimped onto the hose. The nipple may be machined from a round bar stock and the nut may be cold formed, and the nipple, the nut, and the shell may be individually plated prior to assembly.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a perspective and exploded view of an exemplary hose fitting assembly in accordance with embodiments of the present invention.

FIG. 2 is a drawing depicting a perspective view of the hose fitting assembly of FIG. 1 in an assembled state, illustrating the positioning of a nipple component, relative to nut and shell components which are shown in cross-section.

FIG. 3 is a drawing depicting a perspective view of the hose fitting as shown in FIG. 2, with all components shown in cross-section.

FIG. 4 is a drawing depicting a cross-section view of the exemplary hose fitting assembly, with additional views of FIG. 4A, FIG. 4B, and FIG. 4C depicting respective side views in isolation of nut, nipple, and shell components of the hose fitting assembly.

FIG. 5 is a drawing depicting a perspective and exploded view of the exemplary hose fitting assembly that demonstrates assembly of the hose fitting assembly.

FIG. 6 is a drawing depicting a perspective view of the exemplary hose fitting assembly of FIG. 9 in the assembled state.

FIG. 7 is a drawing depicting an outline of a hex bar stock for machining an exemplary nipple component that is representative of the conventional art.

FIG. 8 is a drawing representing in isolation the portion of the hex bar stock from FIG. 7 that gets machined off.

FIG. 9 is a drawing depicting an outline of a round bar stock for machining an exemplary nipple component in accordance with embodiments of the present invention.

FIG. 10 is a drawing representing in isolation the portion of the round bar stock from FIG. 9 that gets machined off.

### DETAILED DESCRIPTION

Embodiments of the present invention will now be described with reference to the drawings, wherein like reference numerals are used to refer to like elements throughout. It will be understood that the figures are not necessarily to scale.

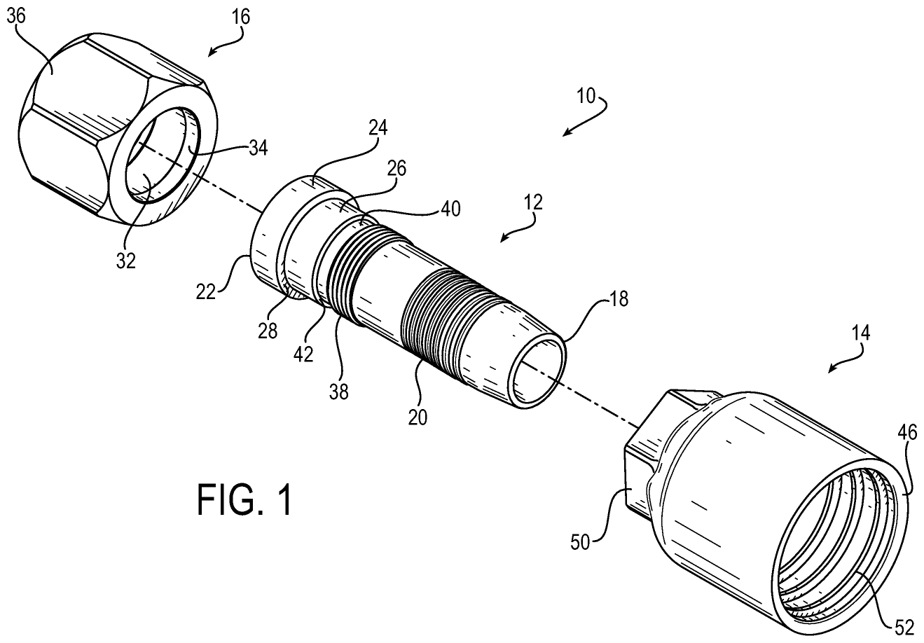

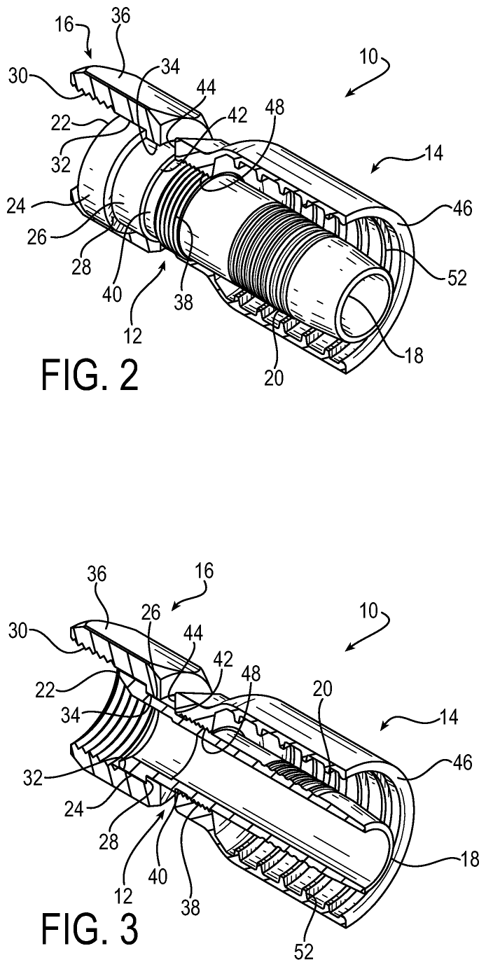

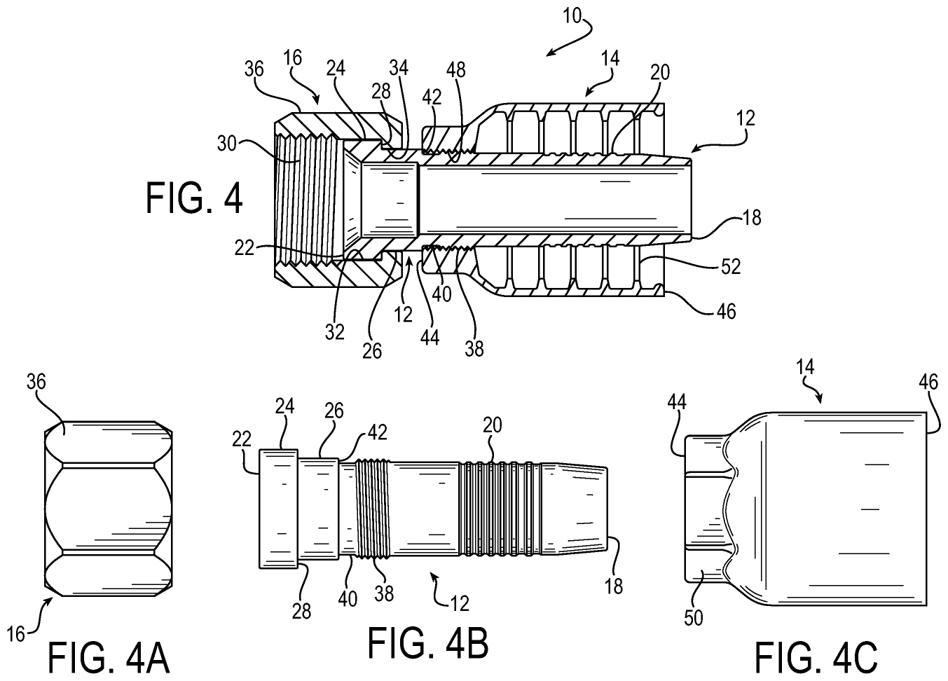

FIGS. 1-4 are drawings depicting various views of an exemplary hose fitting assembly 10 and its associated components, in accordance with embodiments of the present invention. The hose fitting assembly 10 includes a nipple 12, a shell 14, and a nut 16. The nipple 12 includes a first end 18 that is inserted into a hose (not shown). The nipple 12 further may include outer ribs or barbs 20 adjacent to the first end that can provide a tight friction fit with a hose when the nipple is inserted into the hose.

The nipple 12 includes a second end 22 opposite from the first end 18 that is configured to the receive the nut 16. In the assembled state, therefore, the nut 16 is positioned over the second end 22 of the nipple 12. The second end 22 has an external planar surface 24 and a second planar surface 26 of different diameters, which meet to form a step 28. As used generally herein, a “planar surface” is a surface that lacks prominent or significant surface features and therefore is generally smooth, in contrast to a threaded or ribbed surface for example. The nut 16 has a configuration that also is referred to as a full back slip nut. The nut 16 may include an inner threaded surface 30, an inner planar surface 32 that lacks threads and is adjacent to the inner threaded surface, and a lip 34. During assembly, as a full back slip nut, the nut 16 may be slid over the nipple 12 from the first end 18 toward the second end 22, until the lip 34 of the nut 16 reaches the step 28 of the nipple 12. In the assembled position, therefore, the step 28 acts as a stop against the lip 34 of the nut to prevent movement of the nut off of the second end 22 of the nipple 12. As a result, in the assembled position, the inner planar surface 32 of the nut rests against the external planar surface 24 of the nipple, with the inner threaded surface 30 of the nut extending beyond the second end 22 of the nipple to permit connection to system equipment.

The hose fitting assembly 10 can then be connected to external fluid system equipment (not shown) by threading the nut onto a cooperative threaded connection of the system equipment. To aid in assembling the connection, the nut 16 may include a hexagonal shaped outer surface 36, which can be driven using a wrench or comparable tightening tool.

As aspect of the invention is a hose fitting assembly that employs mating threads and a shoulder machined into the nipple to provide a better assembly of the nipple with the shell. In exemplary embodiments, a hose fitting assembly includes a nipple that includes a first end that is insertable into a hose and a second end opposite to the first end, nipple mating threads located between the first and second ends, and a shoulder that is located between the mating threads and the second end and that projects radially outward relative to the nipple mating threads. A nut is positioned over the second end of the nipple. A shell is positioned over the first end of the nipple and includes shell mating threads, wherein the shell is threaded onto the nipple by a threaded connection of the nipple mating threads and the shell mating threads until the shell meets the shoulder. When the shell is threaded onto the nipple, the shoulder operates to prevent further rotation of the shell, and the resulting torque of the interaction of the shell against the shoulder locks the shell in place and provides a seal against leakage from the fitting assembly. The nipple includes a shell locating planar surface that extends from the nipple mating threads towards the second end to a second planar surface, wherein the shell locating planar surface and the second planar surface have different diameters so as to meet to form the shoulder.

Referring to the figures, the nipple 12 may include nipple mating threads 38 that are located between the first end 18 and the second end 22 of the nipple. The nipple 12 further may include a shell locating planar surface 40 adjacent to the nipple matting threads 38 on a second end 22 side of the nipple relative to the mating threads. In other words, the shell locating planar surface 40 extends from the nipple mating threads 38 toward the second end 22 to the second planar surface 26. The second planar surface 26 and shell locating planar surface 40 have different diameters so as to meet to form a shoulder 42. Accordingly, the shoulder 42 is located between the mating threads 38 and the second end 22, and the shoulder 42 projects radially outward relative to the nipple mating threads.

In the assembled state, the shell 14 generally is positioned over the first end 18 of the nipple 12. The shell 14 may include a threaded end 44 and a crimping end 46. The threaded end 44 has an internal surface that includes shell mating threads 48. During assembly, after the full back slip nut 16 is slid and positioned onto the nipple as described above, the shell 14 is threaded onto the nipple 12 by a threaded connection of the nipple mating threads 38 and the shell mating threads 48. The shell is threaded onto the nipple until the threaded end 44 meets the shoulder 42, which prevents further rotation of the shell. The resulting torque of the interaction of the shell against the shoulder locks the shell in place and provides a seal against leakage from the hose fitting assembly, as well as preventing further shell rotation. In exemplary embodiments, the shell and nipple are made of metal, such as for example steel, stainless steel, brass, or comparable suitable material, and thus the threaded connection provides a tight engagement to prevent leakage from the hose fitting assembly, which does not require the use of additional O-rings or other sealing structures as are common in conventional configurations. The use of certain thread types known in the art for effective connection, and/or a thread lock compound applied to the threads, could also be used to create a more robust connection.

In exemplary embodiments, the nipple mating threads 38 and the shell mating thread 48 are left-handed threads. In this manner, when the nut 16 is threaded onto system equipment, the mating threads will prevent the nipple from spinning as the nut is tightened. In addition, to provide a counter hex to the nut tightening and hold the fitting assembly generally in place as the nut is tightened, the threaded end 44 of the shell may have a hexagonal shaped outer shell surface 50, which can be retained also using a wrench or comparable tightening tool similarly as the nut and in a counter fashion. Such a configuration, therefore, aids in connecting the fitting assembly to the system equipment and results in a non-reusable fitting assembly. A suitable shell configuration that may include a hexagonal surface to counter tightening the nut is described in commonly owned U.S. Pat. No. 6,764,106, which is incorporated here by reference. As further detailed below, the use of a hex configuration on the shell eliminates the need to provide a hex portion on the nipple, which permits the nipple to be machined from a simple and relatively small rounded bar stock for a more efficient manufacturing process.

As referenced above, for connecting a hose to system equipment, the nipple 12 is inserted into a hose at the first end 18. Once the hose is positioned on the first end 18 of the nipple and secured via the ribs 20, the crimping end 46 of the shell 14 extends over the hose end with the hose end being located between the outer surface of the nipple and the inner surface of the shell. In such state, the crimping end 46 then may be crimped onto the hose to secure the hose within the hose fitting assembly 10. The inner surface of the crimping end 46 of the shell 14 may include barbs or teeth 52 that can dig or “bite” into the outer hose layer to provide a secure connection.

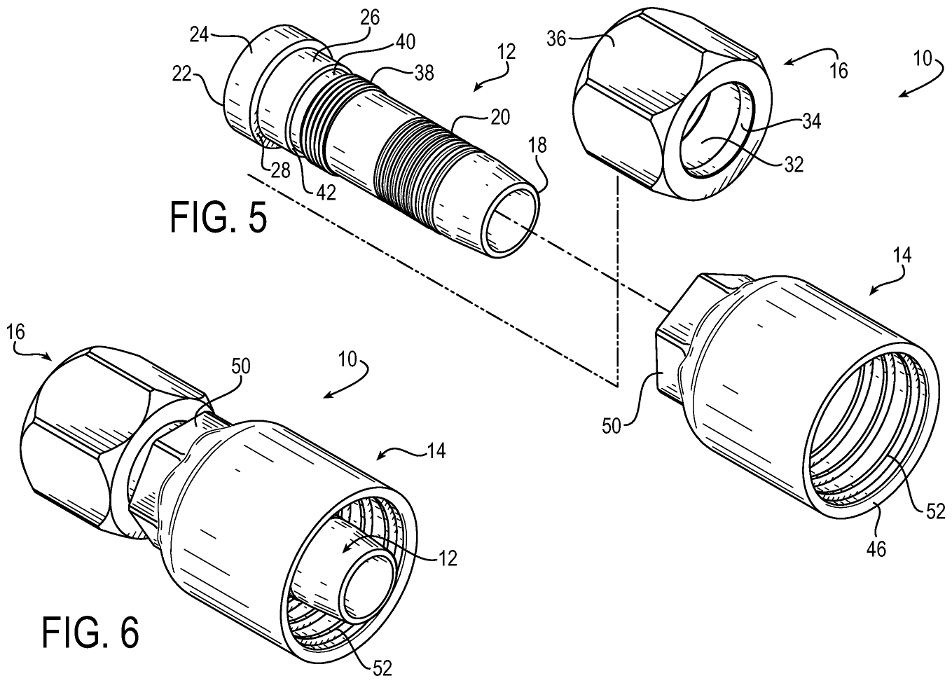

The present invention provides for an enhanced hose fitting configuration that is easier and less costly to manufacture and assemble as compared to conventional configurations. As referenced above, the typical assembly method for conventional hose fitting component parts is to pre-crimp one end of the shell onto a designated area on the nipple to create a connection between the shell and nipple, which can result in an insufficiently robust connection. In configurations of the present disclosure, assembly of the hose fitting components is performed first before the hose is provided. FIG. 5 is a drawing depicting a perspective and exploded view of the exemplary hose fitting assembly that demonstrates assembly of the hose fitting assembly. FIG. 6 is a drawing depicting a perspective view of the exemplary hose fitting assembly of FIG. 5 in the assembled state.

As seen in such figures, the hose fitting assembly 10 may be pre-assembled by sliding the nut 16 over the nipple 12 until the lip 34 of the nut 16 is positioned against the step 28 of the nipple 12. Then the nipple 12 and shell 14 are threaded together via the cooperating mating threads 38 and 48, such that in the assembled state the cooperating mating threads 38 and 48 create a more robust connection to prevent leakage and maintain a secured connection. The shell is therefore threaded onto the nipple until the shell end 44 reaches the shoulder 42 on the nipple that prevents further rotation of the shell. As referenced above, the resulting torque locks the shell in place on the nipple and prevents leakage as well as further shell rotation. Such configuration further provides a simplified design of the individual components, which provides increased efficiency and opportunities for cost reduction in both the assembly of the hose fitting in combining the component parts, and in the initial machining of the component parts.

In a simplified assembly of the hose fitting, the hose fitting components are joined together in the above manner prior to installation of the hose. The hose fitting of the current disclosure provides for a more robust and permanent, non-reusable connection than conventional configurations in which the nut is pre-crimped onto the shell. By providing for a simplified assembly with more limited secondary operations, enhanced efficiency is achieved by use of the hose fitting assembly 10 of the present disclosure.

Additional cost reduction and efficiency opportunities are further realized in the initial machining of the component parts of the hose fitting assembly 10. The hose fitting components typically are made from steel, stainless steel, brass, or comparable suitable material. Machining of a conventional nipple component has required extra machining time and material removal to create specific shapes where the shell mates to the nipple and to counter the tightening of the nut in the conventional configurations. Many of these shapes require a large diameter to achieve, which means the nipple must be cut from bar stock, and usually a hex bar stock, that is larger than is necessary for machining other features to be formed in the nipple.

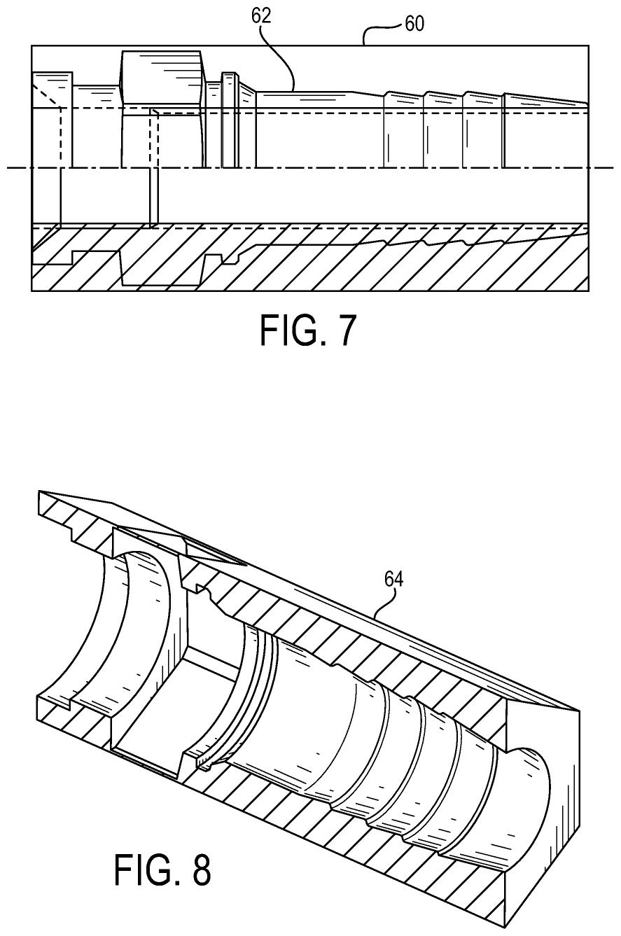

FIG. 7 is a drawing depicting an outer shape of a bar stock 60 for machining an exemplary nipple component 62 that is representative of the conventional art. The shape of the conventional nipple component 62 is outlined in FIG. 7. FIG. 8 is a drawing representing in isolation the portion of the bar stock 64 from FIG. 7 that gets machined off. Accordingly, the bar stock 60 typically is formed of a hex bar stock with the outer hex shape being commensurate with a hex portion of the nipple which conventionally is used for counter tightening the nut. In some conventional configurations, comparable to that of FIG. 7, nipple 62 further includes a variety of ridges and grooves for accommodating additional washers, O-rings, other seals, and like additional components that are employed in conventional configurations to locate the nipple relative to the other component parts (nut and shell), and otherwise seal the fitting. The conventional machining process is therefore costly and requires a relatively large bar stock.

In connection with the hose fitting assembly 10 of the present disclosure, because the nipple 12 of the fitting assembly 10 incorporates the simple small shoulder 42 on the outside of the nipple at an end of the threaded area to prevent further shell rotation, such configuration permits a smaller bar stock to be used as the base material. In addition, the hose fitting assembly 10, with the hex for countering tightening of nut 16 being provided on the shell 14, permits using a round bar stock to machine the nipple 12. A smaller and round bar stock is less expensive and more efficient to machine as compared to conventional configurations.

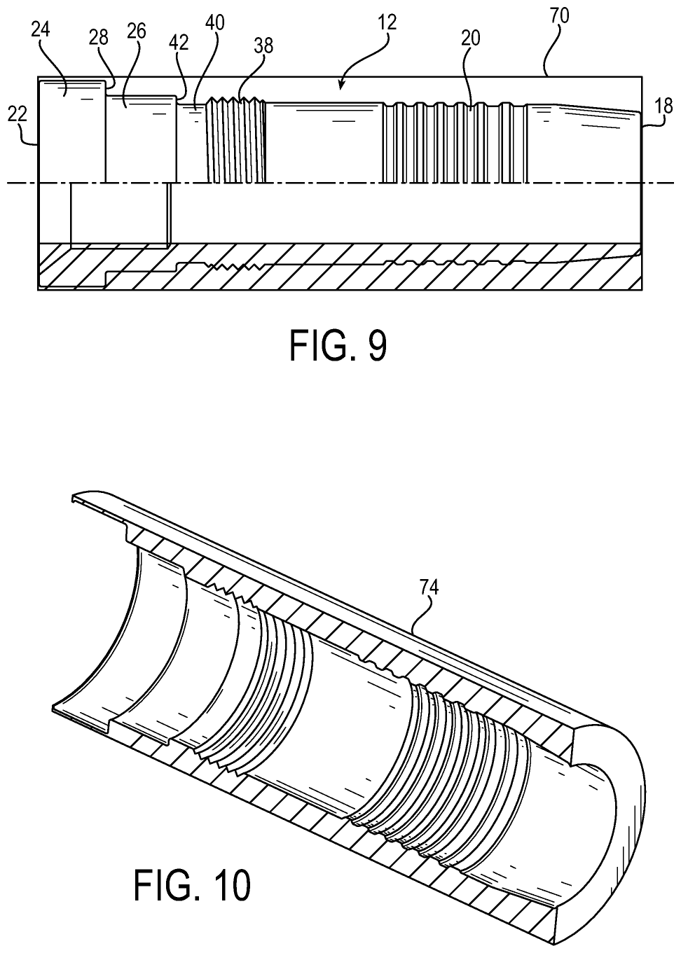

FIG. 9 is a drawing depicting an outer shape of a bar stock 70 for machining the exemplary nipple component 12 in accordance with embodiments of the present invention. Similarly as above with respect to FIG. 7, the shape of the nipple component 12 is outlined in FIG. 9. FIG. 10 is a drawing representing in isolation the portion of the bar stock 74 from FIG. 9 that gets machined off. The bar stock 70 utilized in connection with the present disclosure is a round bar stock with the outer circumference of the bar stock being commensurate with the outermost portion of the nipple, which is the external planar surface 24. In addition, the nipple 12 has far fewer ridges and grooves because the assembly and operation of the fitting assembly 10 does not require additional washers, o-rings, other seals, and like additional components that are employed in some conventional configurations that employ additional structures to locate the nipple and otherwise seal the fitting. Sealing and locating more simply by the nipple 12 is achieved using the mating threads 38 and the shoulder 42, further with the shoulder being formed by the meeting of simple planar surfaces, all which are far simpler to machine and thus permit a smaller bar stock. As a result of permitting use of a round bar stock that also is a smaller bar stock as compared to conventional configurations, the inventors have found there is approximately a 24% volume reduction in machined material as compared to a comparable conventional configuration.

In addition, as referenced above, the configuration of the present disclosure permits a full back slip nut interaction of the nut 16 with respect to the nipple 12, rather than a pre-crimped connection as is conventional. The nut, therefore, can be efficiently produced by cold forming the nut rather than being machined from bar stock and then crimped onto the nipple in a secondary operation as is conventional. A stronger nut 16 can therefore be used in the hose fitting assembly 10. There also is no need to fix the nut location with additional threading in the nipple, or provide additional washers, o-rings, other seals, and like additional components that are employed in some conventional configurations to locate the nipple relative to the nut and shell and otherwise seal the fitting. Additionally, the configuration of the present invention allows the fitting components to be individually plated prior to assembly, increasing the plating coverage and thus anti-corrosion performance.

As aspect of the invention is a hose fitting assembly that employs mating threads and a shoulder machined into the nipple to provide a better assembly of the nipple with the shell. In exemplary embodiments, the hose fitting assembly includes a nipple that includes a first end that is insertable into a hose and a second end opposite to the first end, nipple mating threads located between the first and second ends, and a shoulder that is located between the mating threads and the second end and that projects radially outward relative to the nipple mating threads; a nut positioned over the second end of the nipple; and a shell positioned over the first end of the nipple that includes shell mating threads, wherein the shell is threaded onto the nipple by a threaded connection of the nipple mating threads and the shell mating threads until the shell meets the shoulder. When the shell is threaded onto the nipple the shoulder operates to prevent further rotation of the shell, and the resulting torque of the interaction of the shell against the shoulder locks the shell in place and provides a seal against leakage from the fitting assembly. The hose fitting assembly may include one or more of the following features, either individually or in combination.

In an exemplary embodiment of the hose fitting assembly, the nipple includes a shell locating planar surface that extends from the nipple mating threads towards the second end to a second planar surface, wherein the shell locating planar surface and the second planar surface have different diameters so as to meet to form the shoulder.

In an exemplary embodiment of the hose fitting assembly, the shell has a threaded end that includes the shell mating threads on an inner surface of the threaded end, and an outer surface of the threaded end is hex shaped.

In an exemplary embodiment of the hose fitting assembly, the nut has an external surface that is hex shaped, and the hex shaped outer surface of the threaded end of the shell provides a counter to tightening the nut onto equipment.

In an exemplary embodiment of the hose fitting assembly, the shell includes a crimping end opposite from the threaded end that can be crimped onto the hose, wherein an inner surface of the crimping end includes barbs that bite into an outer layer of the hose when the shell is crimped onto the hose.

In an exemplary embodiment of the hose fitting assembly, the shell and nipple are made of metal, and the threaded connection of the shell and nipple form a metal-to-metal seal.

In an exemplary embodiment of the hose fitting assembly, the nipple includes outer ribs adjacent to the first end that provide a friction fit when the first end of the nipple is inserted into the hose.

In an exemplary embodiment of the hose fitting assembly, the nipple mating threads and the shell mating threads are left-handed threads.

In an exemplary embodiment of the hose fitting assembly: the nipple includes an external planar surface that extends from the second end towards the first end to a second planar surface; the external surface and the second planar surface have different diameters so as to meet to form a step; and the nut includes a lip such that in an assembled position, the step acts as a stop against the lip of the nut to prevent movement of the nut off of the second end of the nipple.

In an exemplary embodiment of the hose fitting assembly, the nut has an inner threaded surface and an inner planar surface adjacent to the inner threaded surface, and in the assembled position the inner planar surface of the nut rests against the external planar surface of the nipple with the inner threaded surface of the nut extending beyond the second end of the nipple for attachment to equipment.

Another aspect of the invention is a method of assembling a hose fitting assembly comprising the steps of: sliding a nut onto a nipple from a first end of the nipple that is insertable into a hose toward a second end opposite to the first end, wherein the nipple has a step and the nut has a lip, and the step acts as a stop against the lip of the nut to prevent movement of the nut off of the second end of the nipple; wherein the nipple has nipple mating threads located between the first and second ends, and a shoulder that is located between the nipple mating threads and the second end and that projects radially outward relative to the nipple mating threads; the method further comprising threading a shell onto the nipple by a threaded connection of the nipple mating threads to shell mating threads until the shell meets the shoulder; and wherein when the shell is threaded onto the nipple the shoulder operates to prevent further rotation of the shell, and the resulting torque of the interaction of the shell against the shoulder locks the shell in place and provides a seal against leakage from the fitting assembly. The assembly method may include one or more of the following features, either individually or in combination.

In an exemplary embodiment of the assembly method, the assembly method further includes: after threading the shell onto the nipple, inserting the first end of the nipple into a hose, and crimping a crimping end of the shell onto the hose.

In an exemplary embodiment of the assembly method, the assembly method further includes attaching the nut to system equipment to make a hose connection.

In an exemplary embodiment of the assembly method: the shell has a threaded end that includes the shell mating threads on an inner surface of the threaded end, and an outer surface of the threaded end is hex shaped; the nut has an external surface that is hex shaped; and the method further comprising using the hex shaped outer surface of the threaded end of the shell as a counter to tightening the nut onto the system equipment.

In an exemplary embodiment of the assembly method, the assembly method further includes machining the nipple from a round bar stock.

In an exemplary embodiment of the assembly method, the assembly method further includes cold forming the nut.

In an exemplary embodiment of the assembly method, the assembly method further includes individually plating the nipple, the nut, and the shell prior to assembly of the nipple, nut, and shell together.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A hose fitting assembly comprising:
a nipple that includes a first end that is insertable into a hose and a second end opposite to the first end, nipple mating threads located between the first and second ends, and a shoulder that is located between the mating threads and the second end and that projects radially outward relative to the nipple mating threads;
a nut positioned over the second end of the nipple; and
a shell positioned over the first end of the nipple that includes shell mating threads, wherein the shell is threaded onto the nipple by a threaded connection of the nipple mating threads and the shell mating threads until the shell meets the shoulder; and
wherein when the shell is threaded onto the nipple the shoulder operates to prevent further rotation of the shell, and the resulting torque of the interaction of the shell against the shoulder locks the shell in place and provides a seal against leakage from the hose fitting assembly.

2. The hose fitting assembly of claim 1, wherein the nipple includes a shell locating planar surface that extends from the nipple mating threads towards the second end to a second planar surface, wherein the shell locating planar surface and the second planar surface have different diameters so as to meet to form the shoulder.

3. The hose fitting assembly of any of claims 1-2, wherein the shell has a threaded end that includes the shell mating threads on an inner surface of the threaded end, and an outer surface of the threaded end is hex shaped.

4. The hose fitting assembly of claim 3, wherein the nut has an external surface that is hex shaped, and the hex shaped outer surface of the threaded end of the shell provides a counter to tightening the nut onto equipment.

5. The hose fitting assembly of any of claims 3-4, wherein the shell includes a crimping end opposite from the threaded end that can be crimped onto the hose, wherein an inner surface of the crimping end includes barbs that bite into an outer layer of the hose when the shell is crimped onto the hose.

6. The hose fitting assembly of any of claims 1-5, wherein the shell and nipple are made of metal, and the threaded connection of the shell and nipple form a metal-to-metal seal.

7. The hose fitting assembly of any of claims 1-6, wherein the nipple includes outer ribs adjacent to the first end that provide a friction fit when the first end of the nipple is inserted into the hose.

8. The hose fitting assembly of any of claims 1-7, wherein the nipple mating threads and the shell mating threads are left-handed threads.

9. The hose fitting assembly of any of claims 1-8, wherein:
the nipple includes an external planar surface that extends from the second end towards the first end to a second planar surface;
the external surface and the second planar surface have different diameters so as to meet to form a step; and
the nut includes a lip such that in an assembled position, the step acts as a stop against the lip of the nut to prevent movement of the nut off of the second end of the nipple.

10. The hose fitting assembly of claim 9, wherein the nut has an inner threaded surface and an inner planar surface adjacent to the inner threaded surface, and in the assembled position the inner planar surface of the nut rests against the external planar surface of the nipple with the inner threaded surface of the nut extending beyond the second end of the nipple for attachment to equipment.

11. A method of assembling a hose fitting assembly comprising the steps of:
sliding a nut onto a nipple from a first end of the nipple that is insertable into a hose toward a second end opposite to the first end, wherein the nipple has a step and the nut has a lip, and the step acts as a stop against the lip of the nut to prevent movement of the nut off of the second end of the nipple;
wherein the nipple has nipple mating threads located between the first and second ends, and a shoulder that is located between the nipple mating threads and the second end and that projects radially outward relative to the nipple mating threads;
the method further comprising threading a shell onto the nipple by a threaded connection of the nipple mating threads to shell mating threads until the shell meets the shoulder; and
wherein when the shell is threaded onto the nipple the shoulder operates to prevent further rotation of the shell, and the resulting torque of the interaction of the shell against the shoulder locks the shell in place and provides a seal against leakage from the fitting assembly.

12. The assembly method of claim 11, further comprising: after threading the shell onto the nipple, inserting the first end of the nipple into a hose, and crimping a crimping end of the shell onto the hose.

13. The assembly method of claim 12, further comprising attaching the nut to system equipment to make a hose connection.

14. The assembly method of claim 13, wherein:
the shell has a threaded end that includes the shell mating threads on an inner surface of the threaded end, and an outer surface of the threaded end is hex shaped;
the nut has an external surface that is hex shaped; and
the method further comprising using the hex shaped outer surface of the threaded end of the shell as a counter to tightening the nut onto the system equipment.

15. The assembly method of any of claims 11-14, further comprising machining the nipple from a round bar stock.

16. The assembly method of any of claims 11-15, further comprising cold forming the nut.

17. The assembly method of any of claims 11-16, further comprising individually plating the nipple, the nut, and the shell prior to assembly of the nipple, nut, and shell together.
